(19) United States
(12) Patent Application Publication
(10) Pub. No.: US 2025/0299886 A1
(43) Pub. Date: Sep. 25, 2025

(54) ELECTRONIC COMPONENT

(71) Applicant: TDK Corporation, Tokyo (JP)

(72) Inventors: Masato KIMURA, Tokyo (JP); Yasuhiro Okui, Tokyo (JP); Yoshitaka Nagashima, Tokyo (JP); Shinya Saito, Tokyo (JP); Anna Hashimoto, Tokyo (JP); Hotaka Watanabe, Tokyo (JP)

(73) Assignee: TDK Corporation, Tokyo (JP)

(21) Appl. No.: 19/061,367

(22) Filed: Feb. 24, 2025

(30) Foreign Application Priority Data
Mar. 21, 2024 (JP) 2024-045170

(51) Int. Cl. H01G 4/30; H01G 4/012; H01G 4/232

(52) U.S. Cl. CPC H01G 4/30; H01G 4/012; H01G 4/232

(57) ABSTRACT

An electronic component includes an element body, a first terminal electrode, a second terminal electrode, an external connection conductor, a first internal electrode, a second internal electrode, and a third internal electrode, in which a first capacitor portion formed by the first internal electrode and the third internal electrode facing each other and a second capacitor portion formed by the second internal electrode and the third internal electrode facing each other are connected in series with each other, and the third internal electrode has an opening portion in a region between the first internal electrode and the second internal electrode when viewed in the first direction.

### CROSS-REFERENCE TO RELATED APPLICATIONS

This application is based upon and claims the benefit of priority from Japanese Patent Application No. 2024-045170, filed on Mar. 21, 2024, the entire contents of which are incorporated herein by reference.

### TECHNICAL FIELD

The present invention relates to an electronic component.

### BACKGROUND

As a conventional capacitor, a capacitor described in Japanese Unexamined Patent Publication No. 2019-46876 is known. The electronic component includes an element body and a pair of terminal electrodes. Internal electrodes are formed inside the element body in such a way as to constitute two capacitor portions. In the element body, first internal electrodes and second internal electrodes arranged in such a way as to be separated from each other and third internal electrodes facing these internal electrodes are formed.

### SUMMARY

It has been desired to improve performance of an electronic component including a plurality of capacitor portions connected in series with each other inside an element body.

The present invention has been made to solve such a problem, and an object thereof is to provide an electronic component including a plurality of capacitor portions connected in series with each other and capable of improving performance.

An electronic component in the present invention includes an element body having a first main surface and a second main surface facing each other in a first direction, a first end surface and a second end surface facing each other in a second direction, which is perpendicular to the first direction, and a first side surface and a second side surface facing each other in a third direction perpendicular to the first direction and the second direction, a first terminal electrode formed on the first end surface, a second terminal electrode formed on the second end surface, an external connection conductor formed on at least one of the first side surface and the second side surface, a first internal electrode provided in the element body and connected to the first terminal electrode at the first end surface, a second internal electrode provided in the element body, separated from the first internal electrode, and connected to the second terminal electrode at the second end surface, and a third internal electrode provided in the element body, facing the first internal electrode and the second internal electrode in the first direction, and connected to the external connection conductor, in which a first capacitor portion formed by the first internal electrode and the third internal electrode facing each other and a second capacitor portion formed by the second internal electrode and the third internal electrode facing each other are connected in series with each other, and the third internal electrode has an opening portion in a region between the first internal electrode and the second internal electrode when viewed in the first direction.

In this electronic component, the first internal electrode connected to the first terminal electrode faces the third internal electrode, and the second internal electrode connected to the second terminal electrode faces the third internal electrode. With this configuration, the first capacitor portion formed by the first internal electrode and the third internal electrode facing each other and the second capacitor portion formed by the second internal electrode and the third internal electrode facing each other are connected in series with each other via the third internal electrode. Even when one capacitor portion is short-circuited, a function of the other capacitor portion can be maintained, which improves reliability. By using the terminal electrodes and the external connection conductor, presence or absence of a short circuit failure in each capacitor portion can be measured and inspected. Here, the third internal electrode has an opening portion in a region between the first internal electrode and the second internal electrode when viewed in the first direction. Electric field intensity, therefore, can be reduced in the vicinity of the region between the first internal electrodes and the second internal electrodes. As a result, cracks in the element body due to electric field enhancement can be suppressed. Performance of the electronic component including a plurality of capacitor portions connected in series with each other can thus be improved.

The third internal electrode may include a first region closer to the first end surface than the opening portion, a second region closer to the second end surface than the opening portion, and a connection portion that couples the first region and the second region with each other, and the connection portion may be formed on a side surface on which the external connection conductor is provided. In this case, the connection portion can be brought close to the external connection conductor. By shortening length of a lead-out portion to the external connection conductor of the third internal electrode, therefore, Joule heat due to a current to the lead-out portion can be reduced, and a possibility of damage due to the Joule heat can be reduced.

The external connection conductor may be formed on the first side surface and the second side surface, and the third internal electrode may include, as the connection portion, a first connection portion connected to the external connection conductor on the first side surface and a second connection portion connected to the external connection conductor on the second side surface. In this case, presence or absence of a short circuit failure can be measured and inspected using the external connection conductor on one of the first side surface and the second side surface.

A width of the connection portion of the third internal electrode in the third direction may be 10% or more of an overlapping width of the first capacitor portion and the second capacitor portion in the third direction. In this case, by securing the width of the connection portion, Joule heat due to a current can be reduced, and damage due to the Joule heat can be suppressed.

A length of the connection portion of the third internal electrode in the second direction may be 100% or less of an overlapping length of the first capacitor portion and the second capacitor portion in the second direction. In this case, by suppressing a length of the connection portion, Joule heat due to a current can be reduced, and damage due to the Joule heat can be suppressed.

A width of the connection portion of the third internal electrode in the third direction may be larger than a width of a lead-out portion connected to the external connection conductor in the second direction. In this case, by securing the width of the connection portion, it is possible to ensure connectivity with the external connection conductor while reducing Joule heat due to a current.

The first internal electrode may include a first lead-out portion led out from the first capacitor portion to the first terminal electrode, the second internal electrode may include a second lead-out portion led out from the second capacitor portion to the second terminal electrode, and the first lead-out portion and the second lead-out portion may be narrower than the first capacitor portion and the second capacitor portion in the third direction. In this case, in the first and second internal electrodes, regions overlapping an edge of the third internal electrode can be reduced in the vicinity of edges of the first capacitor portion and the second capacitor portion on end surface sides. The electric field intensity, therefore, can be reduced in the vicinity of the end surfaces to reduce cracks.

A width of the opening portion in the second direction may be twice or more as large as a thickness of a first dielectric layer between the first and second internal electrodes and the third internal electrode in the first direction. In this case, it is possible to improve withstand voltage performance near the opening portion equal to or more than interlayer withstand voltage performance of the first dielectric layer.

A first mitigation layer that mitigates formation of a recess in the element body may be formed inside the opening portion. In this case, recesses in the main surfaces of the element body can be reduced. Pickup of the element body through suction, therefore, becomes easy.

A second mitigation layer that mitigates formation of a recess in the element body may be formed between the first internal electrode and the second internal electrode. In this case, recesses in the main surfaces of the element body can be reduced. Pickup of the element body through suction, therefore, becomes easy.

The first mitigation layer and the second mitigation layer may be conductor layers or second dielectric layers. In this case, recesses in the main surfaces of the element body can be reduced by sufficiently supporting the inside of the opening portion with the conductor layers or the second dielectric layers. Pickup of the element body through suction, therefore, becomes easy.

According to the present invention, it is possible to provide an electronic component including a plurality of capacitor portions connected in series with each other and capable of improving performance.

### BRIEF DESCRIPTION OF THE DRAWINGS

FIG. 1A is a plan view of an electronic component according to the present embodiment, and FIG. 1B is a front view of the electronic component according to the present embodiment;

FIG. 2A is a cross-sectional view taken along line IIa-IIa illustrated in FIG. 1A, and FIG. 2B is a cross-sectional view taken along line IIb-IIb illustrated in FIG. 1A;

FIG. 3A is a diagram illustrating third internal electrodes, FIG. 3B is a diagram illustrating first internal electrodes and second internal electrodes, and FIG. 3C is a diagram illustrating a positional relationship at a time when the first internal electrodes and the second internal electrodes are overlapped with the third internal electrodes;

FIG. 4 is an exploded perspective view illustrating how layers are stacked on one another;

FIGS. 5A to 5C are diagrams illustrating results of simulation of electric field intensity in a comparative example and the embodiment;

FIG. 6 is a graph showing a relationship between a stacking deviation and an electric field enhancement factor in the comparative example and the embodiment;

FIGS. 7A and 7B are cross-sectional views illustrating the electronic component according to the embodiment, and FIGS. 7C and 7D are cross-sectional views illustrating an electronic component in the comparative example;

FIGS. 8A to 8C are diagrams illustrating internal electrodes of an electronic component according to a modification;

FIGS. 9A to 9C are diagrams illustrating internal electrodes of an electronic component according to another modification;

FIGS. 10A to 10C are diagrams illustrating internal electrodes of an electronic component according to another modification;

FIGS. 11A to 11C are diagrams illustrating internal electrodes of an electronic component according to another modification;

FIGS. 12A to 12C are diagrams illustrating internal electrodes of an electronic component according to another modification;

FIGS. 13A to 13C are diagrams illustrating internal electrodes of an electronic component according to another modification;

FIGS. 14A to 14C are diagrams illustrating internal electrodes of an electronic component according to another modification; and

FIGS. 15A to 15C are diagrams illustrating internal electrodes of an electronic component according to another modification.

### DETAILED DESCRIPTION

An embodiment of the present invention will be described in detail hereinafter with reference to the accompanying drawings. Note that in the description, the same elements or elements having the same functions are given the same reference numerals, and redundant description thereof is omitted.

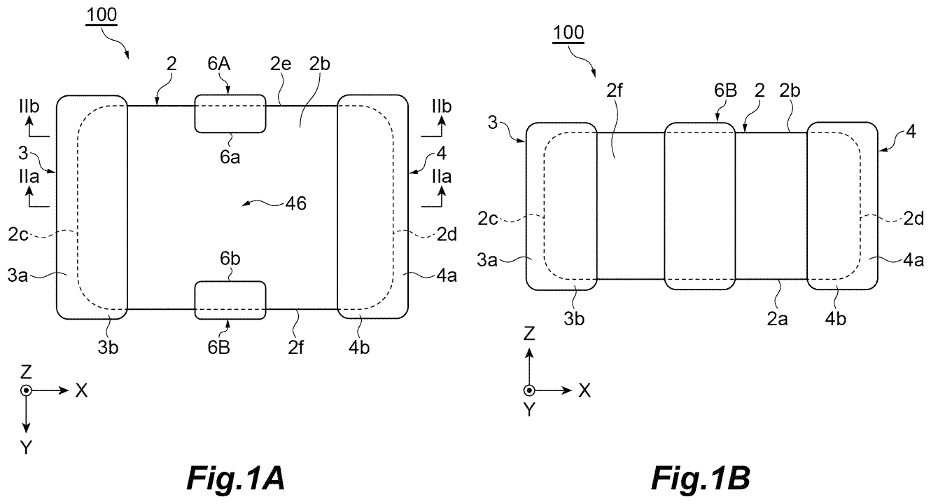

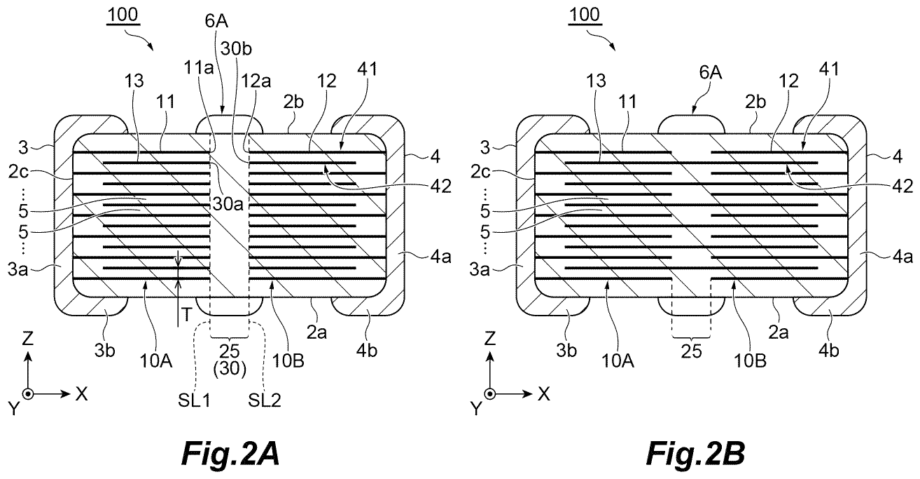

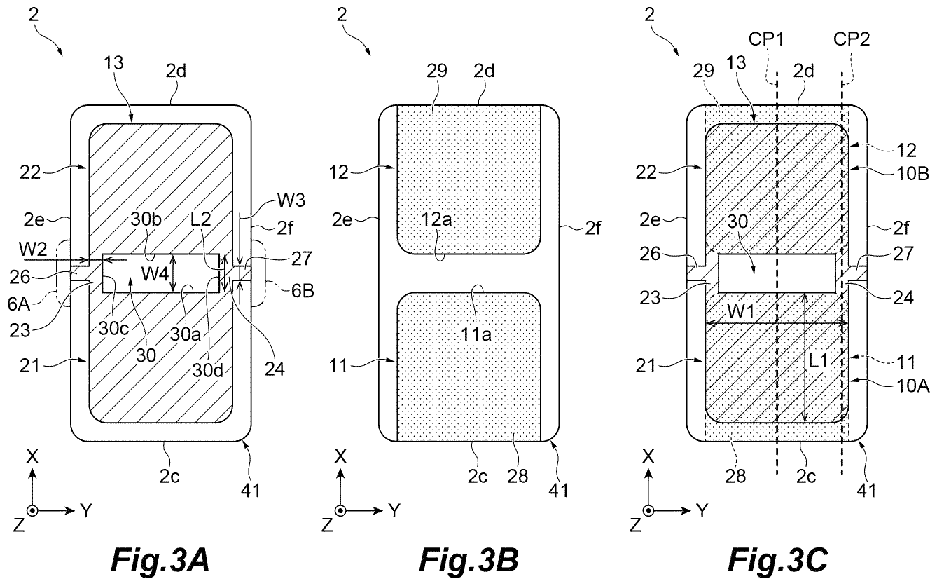

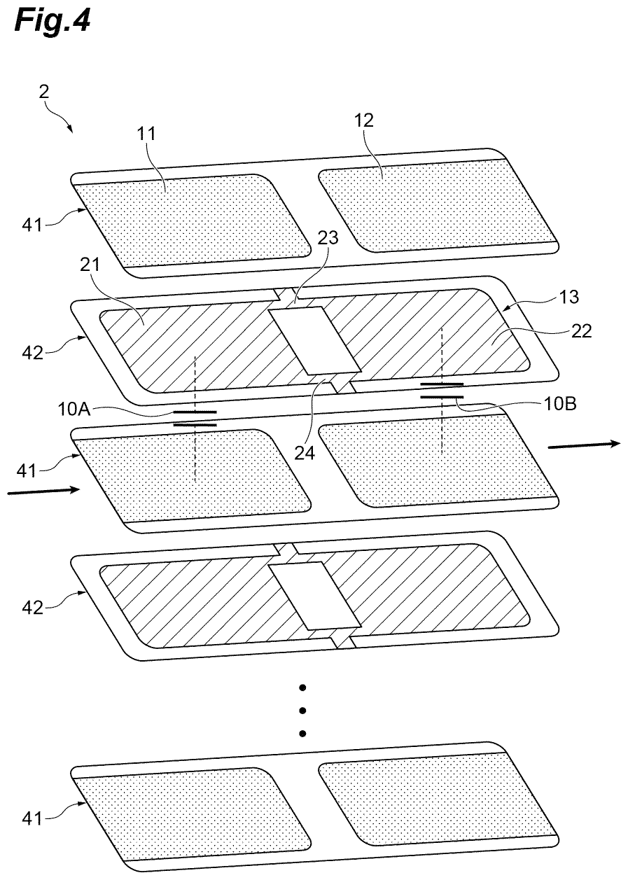

First, configuration of an electronic component 100 according to the present embodiment will be described with reference to FIGS. 1A to 4. FIG. 1A is a plan view of an electronic component according to the present embodiment, and FIG. 1B is a front view of the electronic component according to the present embodiment. FIG. 2A is a cross-sectional view taken along line IIa-IIa illustrated in FIG. 1A, and FIG. 2B is a cross-sectional view taken along line IIb-IIb illustrated in FIG. 1A. A cross-sectional position in FIG. 2A is indicated by a cutting position CP1 in FIG. 3C. The cross-sectional position in FIG. 2B is indicated by a cutting position CP2 in FIG. 3C. FIG. 3A is a diagram illustrating third internal electrodes, FIG. 3B is a diagram illustrating first internal electrodes and second internal electrodes, and FIG. 3C is a diagram illustrating a positional relationship at a time when the first internal electrodes and the second internal electrodes are overlapped with the third internal electrodes. FIG. 4 is an exploded perspective view illustrating how layers are stacked on one another. In FIG. 3C, the first internal electrodes and the second internal electrodes are indicated by virtual lines.

In the following description, an XYZ coordinate system might be set for the electronic component 100. A Z-axis direction (first direction) is a stacking direction in which internal electrodes described later are stacked on one another. The Z-axis direction is a direction perpendicular to a surface of a circuit board to be mounted at a time of mounting. An X-axis direction (second direction) is a direction perpendicular to the Z-axis direction, and is a direction parallel to the surface of the circuit board at the time of mounting. The X-axis direction corresponds to a longitudinal direction in which an element body 2 extends. A Y-axis direction (third direction) is a direction perpendicular to the Z-axis direction and the X-axis direction, and is a direction parallel to the surface of the circuit board at the time of mounting and perpendicular to the X-axis direction. In FIG. 1B, an upper side is a positive side in the Z-axis direction, and a lower side is a negative side in the Z-axis direction.

As illustrated in FIGS. 1A and 1B, the electronic component 100 includes the element body 2, a first terminal electrode 3, a second terminal electrode 4, and first and second external connection conductors 6A and 6B. As illustrated in FIGS. 2A and 2B, the electronic component 100 includes first internal electrodes 11, second internal electrodes 12, and third internal electrodes 13 in the element body 2.

As illustrated in FIGS. 1A and 1B, the element body 2 is a rectangular parallelepiped component extending along the X-axis direction, which is the longitudinal direction. The element body 2 includes a first main surface 2a and a second main surface 2b facing each other in the Z-axis direction, a first end surface 2c and a second end surface 2d facing each other in the X-axis direction, and a first side surface 2e and a second side surface 2f facing each other in the Y-axis direction. The first main surface 2a is disposed on the negative side in the Z-axis direction, and the second main surface 2b is disposed on the positive side in the Z-axis direction. The first end surface 2c is disposed on a negative side in the X-axis direction, and the second end surface 2d is disposed on a positive side in the X-axis direction. The first side surface 2e is disposed on a negative side in the Y-axis direction, and the second side surface 2f is disposed on a positive side in the Y-axis direction. Among these surfaces, the first main surface 2a is a mounting surface that faces a mounting substrate at the time of mounting.

A shape of the element body 2 is not particularly limited, but here, the element body 2 has a rectangular parallelepiped shape in which a dimension in the X-axis direction is larger than dimensions in the Z-axis direction and the Y-axis direction. The rectangular parallelepiped shape includes a rectangular parallelepiped shape in which corners and ridge lines are chamfered and a rectangular parallelepiped shape in which corners and ridge lines are rounded. For example, length of the element body 2 in the X-axis direction may be 0.5 to 7.7 mm, length in the Y-axis direction may be 0.29 to 4.7 mm, and length in the Z-axis direction may be 0.29 to 4.0 mm.

The element body 2 includes a plurality of dielectric layers (dielectric layers 5 illustrated in FIG. 2A) stacked on one another in the Z-axis direction. Each dielectric layer is, for example, a sintered body of a ceramic green sheet containing, for example, a dielectric material (dielectric ceramic such as BaTiO₃-based, Ba(Ti, Zr)O₃-based, or (Ba, Ca)TiO₃-based). In the actual element body 2, the dielectric layers 5 are so closely integrated that boundaries between the dielectric layers 5 cannot be visually recognized.

The terminal electrodes 3 and 4 are provided in such a way as to cover the end surfaces 2c and 2d of the element body 2. The terminal electrodes 3 and 4 are portions for electrically connecting other members and the electronic component 100 to each other. The terminal electrodes 3 and 4 include main portions 3a and 4a and wraparound portions 3b and 4b. The main portions 3a and 4a are formed on the end surfaces 2c and 2d of the element body 2. The main portions 3a and 4a are formed in such a way as to cover the entirety of the end surfaces 2c and 2d. The wraparound portions 3b and 4b are formed in such a way as to wrap around from the main portions 3a and 4a to the main surfaces 2a and 2b and the side surfaces 2e and 2f. The wraparound portion 3b is formed in such a way as to cover part of the main surfaces 2a and 2b and the side surfaces 2e and 2f near the first end surface 2c. The wraparound portion 4b is formed in such a way as to cover part of the main surfaces 2a and 2b and the side surfaces 2e and 2f near the second end surface 2d.

The first external connection conductor 6A is a conductor coupled with the plurality of third internal electrodes 13 outside the element body 2. The second external connection conductor 6B is a conductor coupled with the plurality of third internal electrodes 13 outside the element body 2. The first and second external connection conductors 6A and 6B are formed on the element body 2 at a substantially central position in the X-axis direction. The first and second external connection conductors 6A and 6B are formed in such a way as to be separated from the terminal electrodes 3 and 4 in the X-axis direction. The first external connection conductor 6A is formed on the side surface 2e. The first external connection conductor 6A extends over an entire length of the side surface 2e in the Z-axis direction. The first external connection conductor 6A wraps around the main surfaces 2a and 2b. The second external connection conductor 6B is formed on the side surface 2f. The second external connection conductor 6B extends over an entire length of the side surface 2f in the Z-axis direction. The second external connection conductor 6B wraps around the main surfaces 2a and 2b. Ends 6a and 6b of the first and second external connection conductors 6A and 6B on the main surface 2b are separated from each other in the Y-axis direction. Ends (not illustrated, but the same configuration as on the main surface 2b in FIG. 1A) of the first and second external connection conductors 6A and 6B on the main surface 2a are separated from each other in the Y-axis direction. As a result, regions around central positions of the first and second main surfaces 2a and 2b are exposed from the first and second external connection conductors 6A and 6B. With such a configuration, the first and second external connection conductors 6A and 6B are mechanically and electrically separated from each other.

Materials of the terminal electrodes 3 and 4 and the external connection conductor 6 are not particularly limited, but may include copper. The terminal electrodes 3 and 4 and the first and second external connection conductors 6A and 6B may be copper sintered layers, and Ni-plated layers, Sn-plated layers, or the like may be formed on these sintered layers. The terminal electrodes 3 and 4 and the external connection conductors 6 may include a conductive resin layer of a material such as silver.

As illustrated in FIGS. 2A and 2B, the internal electrodes 11,12, and 13 are flat conductor patterns extending parallel to an XY plane. A plurality of internal electrodes 11,12, and 13 are formed in the Z-axis direction. The first internal electrodes 11 are provided in a region of the element body 2 on the negative side in the X-axis direction, and are connected to the first terminal electrode 3 at the first end surface 2c. The second internal electrodes 12 are provided in a region of the element body 2 on the positive side in the X-axis direction, and are connected to the second terminal electrode 4 at the second end surface 2d. The first internal electrodes 11 and the second internal electrodes 12 are disposed in the same plane. That is, the first internal electrodes 11 and the second internal electrodes 12 are formed on the same dielectric layers 5, and located at the same positions in the Z-axis direction. In a state before the stacking, conductor patterns of the first internal electrodes 11 and the second internal electrodes 12 are formed on the ceramic green sheets of the dielectric layers 5. The first internal electrodes 11 and the second internal electrodes 12 are mechanically (physically and structurally) separated (isolated) from each other. Note that the layers including the first internal electrodes 11 and the second internal electrodes 12 might be referred to as first electrode layers 41. When internal electrodes are separated from each other, a material of a dielectric layer 5 is interposed in an entire region between one internal electrode and the other internal electrode.

The third internal electrodes 13 are provided in regions of the element body 2 on both the negative and positive sides in the X-axis direction, and extend to the first side surface 2e and the second side surface 2f (see FIG. 3A). In the state before the stacking, the third internal electrodes 13 are formed on the ceramic green sheets of the dielectric layers 5. The layers including the third internal electrodes 13 might be referred to as second electrode layers 42.

As illustrated in FIGS. 3A to 3C, in the Z-axis direction, the first internal electrodes 11 face a part of a first region 21 of the third internal electrodes 13 on the negative side in the X-axis direction without facing the second internal electrodes 12. In the Z-axis direction, the second internal electrodes 12 face a part of a second region 22 of the third internal electrodes 13 on the positive side in the X-axis direction without facing the first internal electrodes 11. The first internal electrodes 11 and the first region 21 are disposed in such a way as to be separated from the second internal electrodes 12 and the second region 22 with a gap therebetween in the X-axis direction.

An example of a specific shape of each of the internal electrodes 11,12, and 13 will be described with reference to FIGS. 3A and 3B. As illustrated in FIG. 3B, the first internal electrodes 11 extend toward the central position of the element body 2, that is, toward the positive side in the X-axis direction, from the first end surface 2c. Inner edges 11a of the first internal electrodes 11 in the X-axis direction (the positive side in the X-axis direction) extend parallel to the Y-axis direction. Edges of the first internal electrodes 11 on the negative side in the X-axis direction are exposed from the first end surface 2c and connected to the first terminal electrode 3. Edges of the first internal electrodes 11 on the negative side in the Y-axis direction are separated from and parallel to the first side surface 2e. Edges of the first internal electrodes 11 on the positive side in the Y-axis direction are separated from and parallel to the second side surface 2f.

The second internal electrodes 12 extend toward the central position of the element body 2, that is, toward the negative side in the X-axis direction, from the second end surface 2d. Inner edges 12a of the second internal electrodes 12 in the X-axis direction (the negative side in the X-axis direction) extend parallel to the Y-axis direction. The edges 12a of the second internal electrodes 12 are parallel to the edges 11a of the first internal electrodes 11 while being separated from the edges 11a in the X-axis direction. Edges of the second internal electrodes 12 on the positive side in the X-axis direction are exposed from the second end surface 2d and connected to the second terminal electrode 4. Edges of the second internal electrodes 12 on the negative side in the Y-axis direction are separated from and parallel to the first side surface 2e. Edges of the second internal electrodes 12 on the positive side in the Y-axis direction are separated from and parallel to the second side surface 2f. The edges of the second internal electrodes 12 on both sides in the Y-axis direction are disposed at the same positions in the Y-axis direction as the edges of the first internal electrodes 11 on both sides in the Y-axis direction.

As illustrated in FIG. 3A, the third internal electrodes 13 include the first region 21, the second region 22, a first connection portion 23, a second connection portion 24, a lead-out portion 26, and an lead-out portion 27. The third internal electrodes 13 have an opening portion 30 in a region between the first internal electrodes 11 and the second internal electrodes 12 when viewed in the Z-axis direction.

The first region 21 is a region closer to the first end surface 2c than the opening portion 30. The first region 21 is a portion disposed in such a way as to overlap the first internal electrodes 11 (see FIG. 3C). An edge of the first region 21 on the positive side in the X-axis direction (an edge 30a of the opening portion 30) extends parallel to the Y-axis direction. An edge of the first region 21 on the negative side in the X-axis direction is separated from the first end surface 2c toward the positive side in the X-axis direction. Edges of the first region 21 on both sides in the Y-axis direction have the same shapes as and are disposed at the same positions as the ends of the first internal electrodes 11 on both sides in the Y-axis direction (see FIG. 3C).

The second region 22 is a region closer to the second end surface 2d than the opening portion 30. The second region 22 is a portion disposed in such a way as to overlap the second internal electrodes 12 (see FIG. 3C). An edge of the second region 22 on the negative side in the X-axis direction (an edge 30b of the opening portion 30) extends parallel to the Y-axis direction. An edge of the second region 22 on the positive side in the X-axis direction is separated from the second end surface 2d toward the negative side in the X-axis direction. Edges of the second region 22 on both sides in the Y-axis direction have the same shapes as and are disposed at the same positions as the ends of the second internal electrodes 12 on both sides in the Y-axis direction (see FIG. 3C).

The first connection portion 23 and the second connection portion 24 couple the first region 21 and the second region 22 with each other. The first connection portion 23 is formed near the first side surface 2e, where the first external connection conductor 6A is provided. The first connection portion 23 is connected to the first external connection conductor 6A via the lead-out portion 26 on the first side surface 2e. An edge of the first connection portion 23 on the negative side in the Y-axis direction extends in the X-axis direction at the same position in the Y-axis direction as the edges of the first and second regions 21 and 22 on the negative side in the Y-axis direction. An edge of the first connection portion 23 on the positive side in the Y-axis direction (an edge 30c of the opening portion 30) is an edge defining an edge of the opening portion 30 on the negative side in the Y-axis direction, and extends in the X-axis direction. The second connection portion 24 is formed near the second side surface 2f on which the second external connection conductor 6B is provided. The second connection portion 24 is connected to the second external connection conductor 6B via the lead-out portion 27 on the second side surface 2f. An edge of the second connection portion 24 on the negative side in the Y-axis direction extends in the X-axis direction at the same position in the Y-axis direction as the edges of the first and second regions 21 and 22 on the positive side in the Y-axis direction. An edge of the second connection portion 24 on the negative side in the Y-axis direction (an edge 30d of the opening portion 30) is an edge defining an edge of the opening portion 30 on the positive side in the Y-axis direction, and extends in the X-axis direction.

The lead-out portion 26 extends from the first connection portion 23 to the negative side in the Y-axis direction, and is exposed from the first side surface 2e to be connected to the first external connection conductor 6A. The lead-out portion 26 extends parallel to the Y-axis direction from a central position of the first connection portion 23 in the X-axis direction. As long as the lead-out portion 26 is connected to the first external connection conductor 6A, however, a position of the lead-out portion 26 in the X-axis direction is not particularly limited, and may extend obliquely in the Y-axis direction. The lead-out portion 27 extends from the second connection portion 24 to the positive side in the Y-axis direction, and is exposed from the second side surface 2f to be connected to the second external connection conductor 6B. The lead-out portion 27 extends parallel to the Y-axis direction from a central position of the second connection portion 24 in the X-axis direction. As long as the lead-out portion 27 is connected to the second external connection conductor 6B, however, a position of the lead-out portion 27 in the X-axis direction is not particularly limited, and may extend obliquely in the Y-axis direction.

The opening portion 30 is a region where a conductor layer constituting the third internal electrodes 13 is not provided. Note that as in the case of a first mitigation layer 31 described later, a conductor layer separated from the third internal electrodes 13 may be provided in the opening portion 30. The opening portion 30 is a region defined by the edges 30a, 30b, 30c, and 30d. The edge 30a is an edge of the first region 21 on the positive side in the X-axis direction. The edge 30b is an edge of the second region 22 on the negative side in the X-axis direction. The edge 30c is an edge of the first connection portion 23 on the positive side in the Y-axis direction. The edge 30d is an edge of the second connection portion 24 on the negative side in the Y-axis direction. In the present embodiment, the opening portion 30 has a rectangular shape having a longitudinal direction in the Y-axis direction. A shape of the opening portion 30 is not particularly limited, and may be an oval shape or the like, instead. The opening portion 30 may be formed in a range including at least a central position of the element body 2 in the Y-axis direction. Size of the opening portion 30 and the like will be described later.

In the present embodiment, the first internal electrodes 11 do not overlap the second internal electrodes 12 and the second region 22 in the Z-axis direction. The second internal electrodes 12 do not overlap the first internal electrodes 11 and the first region 21 in the Z-axis direction. The internal electrodes 11,12, and 13 are mechanically and electrically separated from one another.

As illustrated in FIGS. 2A and 2B, when viewed in the Z-axis direction, the element body 2 has, at a position of the opening portion 30, a gap 25 in which the internal electrodes 11,12, and 13 are not formed. Specifically, the gap 25 is configured by combining a gap between the edges 11a of the first internal electrodes 11 and the edges 12a of the second internal electrodes 12, and a gap between the edge 30a and the edge 30b of the opening portion 30 of the third internal electrodes 13. A continuous combination of these gaps in the Z-axis direction forms the gap 25.

Order of stacking of the first electrode layers 41 and the second electrode layers 42 is not particularly limited, but order illustrated in FIG. 4, for example, may be employed. As illustrated in FIG. 4, in the element body 2, the plurality of first electrode layers 41 and the plurality of second electrode layers 42 are stacked on one another. The first electrode layers 41 and the second electrode layers 42 are alternately stacked. That is, a first electrode layer 41, a second electrode layer 42, another first electrode layer 41, and another second electrode layer 42 are stacked on one another in this order from the bottom, and this order of stacking is repeated.

The first internal electrodes 11 and the second internal electrodes 12 are disposed as outermost layers in multilayer internal electrodes. That is, among internal electrodes disposed inside the element body 2, the first internal electrodes 11 and the second internal electrodes 12 are disposed on the most positive side in the Z-axis direction, and the first internal electrodes 11 and the second internal electrodes 12 are disposed on the most negative side in the Z-axis direction.

Next, a circuit structure formed with the multilayer structure will be described. First, as illustrated in FIG. 4, a current flows through the first internal electrodes 11. A first capacitor portion 10A is formed between the first internal electrodes 11 and the first region 21 of the third internal electrodes 13. The first region 21 and the second region 22 of the third internal electrodes 13 are connected via the connection portions 23 and 24. A second capacitor portion 10B is formed between the second region 22 of the third internal electrodes 13 and the second internal electrodes 12. As a result, the first capacitor portion 10A formed by the first internal electrodes 11 and the first region 21 facing each other and the second capacitor portion 10B formed by the second internal electrodes 12 and the second region 22 facing each other are connected in series with each other via the connection portions 23 and 24.

Note that the first internal electrodes 11 include first lead-out portions 28 led out from the first capacitor portion 10A to the first terminal electrode 3 (see FIGS. 3B and 3C). The second internal electrodes 12 include second lead-out portions 29 led out from the second capacitor portion 10B to the second terminal electrode 4 (FIGS. 3B and 3C).

Next, dimensional relationships will be described. As illustrated in FIG. 3C, an overlapping width W1 of the first capacitor portion 10A and the second capacitor portion 10B in the Y-axis direction may be set to 0.25 to 4.3 mm. An overlapping length L1 of the first capacitor portion 10A and the second capacitor portion 10B in the X-axis direction may be set to 0.20 to 3.8 mm.

As illustrated in FIG. 3A, a width W2 of the connection portions 23 and 24 of the third internal electrodes 13 in the Y-axis direction may be 10% or more, and more preferably 12% or more, of the overlapping width W1 of the first capacitor portion 10A and the second capacitor portion 10B in the Y-axis direction. An upper limit value of the width W2 of the connection portions 23 and 24 is not particularly limited, but may be 45% or less of the overlapping width W1. The width W2 of the connection portions 23 and 24 of the third internal electrodes 13 in the Y-axis direction may be larger than a width W3, in the X-axis direction, of the lead-out portions 26 and 27 connected to the external connection conductors 6A and 6B. Size of the width W2 of the connection portions 23 and 24 with respect to the width W3 of the lead-out portions 26 and 27 is not particularly limited, but the width W2 may be 105 to 3,500% of the width W3.

As illustrated in FIG. 3A, a length L2 of the connection portions 23 and 24 of the third internal electrodes 13 in the X-axis direction may be 100% or less, and more preferably 70% or less, of the overlapping length L1 of the first capacitor portion 10A and the second capacitor portion 10B in the X-axis direction. A lower limit value of the length L2 of the connection portions 23 and 24 is not particularly limited, but may be twice or more as large as a thickness T of the dielectric layer 5.

As illustrated in FIG. 3C, the lead-out portions 28 and 29 of the internal electrodes 11 and 12 may have an area larger than that of the connection portions 23 and 24 of the third internal electrodes 13. The area of the lead-out portions 28 and 29 of the internal electrodes 11 and 12 may be 103 to 1,000% of the area of the connection portions 23 and 24 of the third internal electrodes 13.

A width W4 of the opening portion 30 in the X-axis direction may be twice or more, more preferably five times or more, as large as the thickness T, in the Z-axis direction, of the dielectric layer 5 (see FIGS. 2A and 2B) between the internal electrodes 11,12 and the third internal electrodes 13. An upper limit value of the width W4 of the opening portion 30 is not particularly limited, but may be 1,000 times or less as large as the thickness T of the dielectric layer 5. The thickness T of the dielectric layer 5 is not particularly limited, but may be set to about 1 to 50 μm. Note that a dimension between the edges 11a and 12a of the internal electrodes 11 and 12 in the X-axis direction may be substantially equal to the width W4 of the opening portion 30. A width of the gap 25 in the X-axis direction, therefore, may be substantially equal to the width W4 of the opening portion 30. The width of the gap 25 in the X-axis direction is a maximum dimension of the gap 25 in the X-axis direction.

Here, as illustrated in FIG. 2A, the edge 30a of the opening portion 30 on the negative side in the X-axis direction is preferably disposed at the same position as the edges 11a of the first internal electrodes 11 in the X-axis direction. The edge 30b of the opening portion 30 on the positive side in the X-axis direction is preferably disposed at the same position as the edges 12a of the second internal electrodes 12 in the X-axis direction. In the cross-sectional view illustrated in FIG. 2A, a reference line SL1 extending in the Z-axis direction with respect to positions of the edges 11a of the first internal electrodes 11 is set, and a reference line SL2 extending in the Z-axis direction with respect to positions of the edges 12a of the second internal electrodes 12 is set. At this time, the edges 30a and 30b of the opening portion 30 are preferably arranged on the reference lines SL1 and SL2. Dimensions between the edges 30a and 30b of the opening portion 30 and the reference lines SL1 and SL2 in the X-axis direction will be referred to as “stacking deviations”. A state in which there are no deviations in the X-axis direction between the edges 11a and 12a and the edges 30a and 30b is “stacking deviations=0”. The stacking deviations between the edges 11a and 12a and the edges 30a and 30b are allowed within a predetermined range.

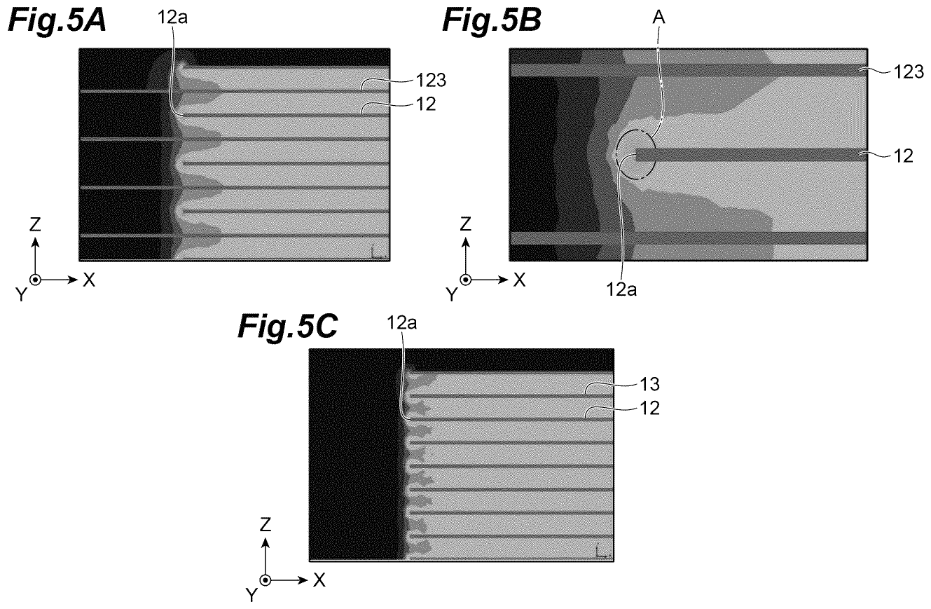

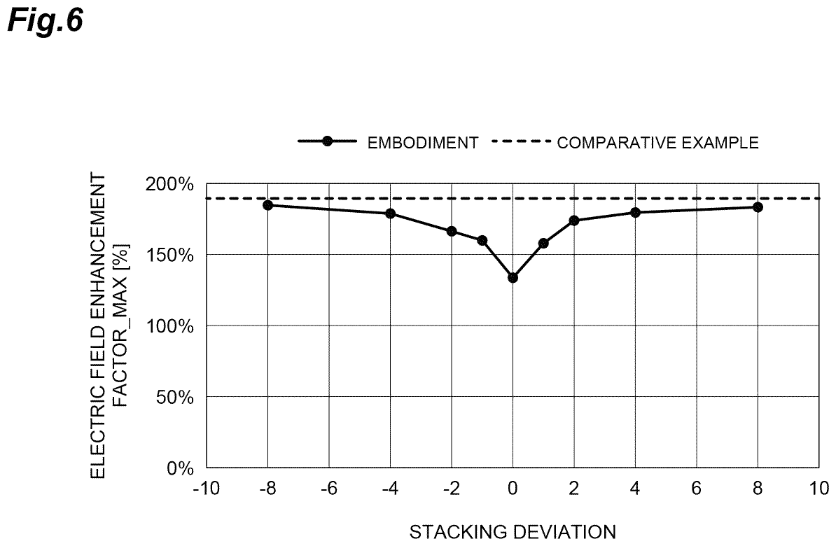

The allowable range of the stacking deviations will be described with reference to FIGS. 5A to 5C and 6. FIG. 5A is a diagram illustrating a result of simulation of electric field intensity for a model of an electronic component in a comparative example. The electronic component in the comparative example employs the third internal electrodes 123 with no opening portion 30. At this time, the third internal electrodes extend above and below the edges 12a of the second internal electrodes 12 on both sides in the Y-axis direction. In this case, as indicated by A in FIG. 5B, a portion where the electric field intensity increases is formed in the vicinity of the edge 12a. An electric field enhancement factor was calculated on the basis of a maximum value of the electric field intensity at this time and set in a graph of FIG. 6. The electric field enhancement factor is a parameter indicating a relative electric field intensity at a position where the electric field intensity is maximized when the electric field intensity at the center of a capacitor portion is 1.

Next, a model of the electronic component according to the embodiment having the opening portion 30 was prepared, and the electric field intensity was simulated. Here, measurement was performed while changing the stacking deviations on both the positive side and the negative side in the X-axis direction. The electric field enhancement factor in each result was calculated and plotted on the graph of FIG. 6. In the graph of FIG. 6, a horizontal axis represents the stacking deviation, and a vertical axis represents the electric field enhancement factor. Note that the stacking deviation is indicated by a multiple at a time when the thickness T of the dielectric layer 5 is 1. When the stacking deviation is 0, the electric field intensity in the vicinity of the edges 12a is reduced as illustrated in FIG. 5C. As illustrated in FIG. 6, the electric field enhancement factor increases as the stacking deviation increases. When the stacking deviation is “the thickness T of the dielectric layer×8”, the electric field enhancement factor is substantially the same as that in the comparative example. As described above, by setting the stacking deviation to eight times or less as large as the thickness T of the dielectric layer 5, electric field enhancement can be effectively suppressed.

Note that an electric field intensity simulation based on a finite element method was performed. Dimensions of the electronic components in the embodiment and the comparative examples were set as follows. Specifically, in the element body 2, “the length L in the X-axis direction=1.6 mm, the width W in the Y-axis direction=0.8 mm, the thickness T in the Z-axis direction=0.8 mm”. The thickness of the dielectric layer was 1 to 5 μm. The opening portion 30 had a dimension of 0.1 to 0.3 mm in the X-axis direction and a dimension of 0.36 mm in the Y-axis direction.

Next, functions and effects of the electronic component 100 according to the present embodiment will be described.

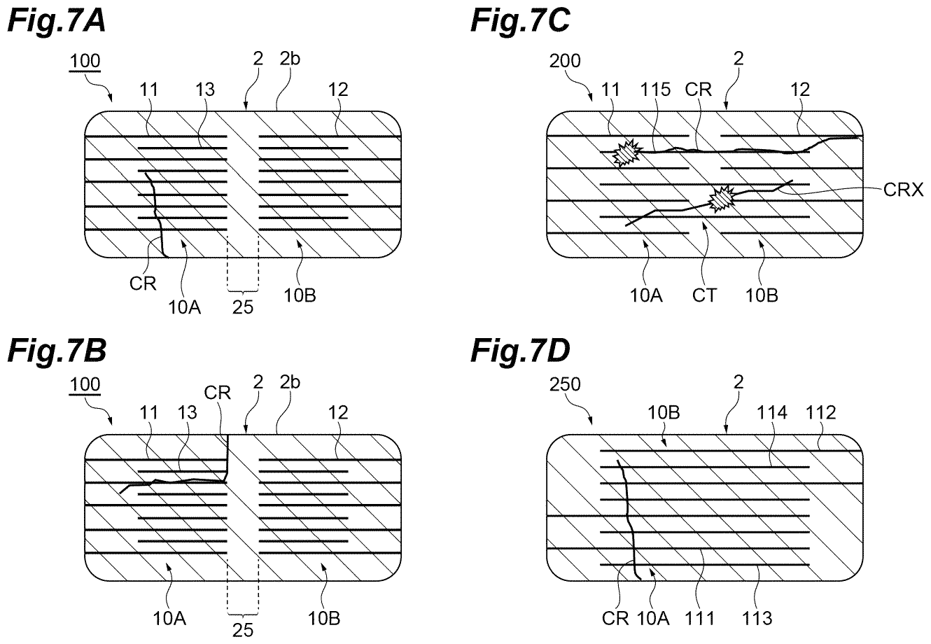

First, the electronic component in the comparative example will be described. FIG. 7C is a schematic cross-sectional view illustrating an internal structure of an element body 2 of an electronic component 200 in the comparative example. The electronic component 200 includes, instead of the internal electrodes 13 in the present embodiment, internal electrodes 115 that simultaneously form a first capacitor portion 10A and a second capacitor portion 10B but that do not have an opening portion 30. The internal electrodes 115 are not connected to an external connection conductor. The internal electrodes 115 extend in such a way as to face both first internal electrodes 11 and second internal electrodes 12. A gap 25, therefore, is not formed in the element body 2, and the internal electrodes 115 include coupling portions CT that couple the first capacitor portion 10A and the second capacitor portion 10B with each other. Since the electronic component 200 does not include an external connection conductor, when one of the first capacitor portion 10A and the second capacitor portion 10B is short-circuited, the short circuit cannot be detected. In addition, when a crack CR occurs in the first capacitor portion 10A, there is a possibility that the crack CR reaches the other second capacitor portion 10B along one of the coupling portions CT. In this case, both capacitor portions 10A and 10B are short-circuited due to an effect of the short circuit of the first capacitor portion 10A.

FIG. 7D is a schematic cross-sectional view of an electronic component 250 in the comparative example having a configuration disclosed in Japanese Unexamined Patent Publication No. 2019-46876. The electronic component 250 includes capacitor portions 10A and 10B in a stacking direction. Although it is possible to detect a short circuit of each of the capacitor portions 10A and 10B in the electronic component 250, there is a possibility that both capacitor portions 10A and 10B are short-circuited when a deflection crack CR occurs, since an interlayer distance is short.

In the electronic component 100 according to the present embodiment, on the other hand, the first internal electrodes 11 connected to the first terminal electrode 3 face the first region 21 of the third internal electrodes 13, and the second internal electrodes 12 connected to the second terminal electrode 4 face the second region 22 of the third internal electrodes 13. Here, the first region 21 and the second region 22 of the third internal electrodes 13 are electrically connected to each other via the connection portions 23 and 24. With such a configuration, the first capacitor portion 10A formed by the first internal electrodes 11 and the first region 21 facing each other and the second capacitor portion 10B formed by the second internal electrode 12 and the second region 22 facing each other are connected in series with each other via the connection portions 23 and 24. Reliability, therefore, can be improved. As illustrated in FIG. 7A, for example, even if a crack CR occurs in the capacitor portion 10A and a short circuit occurs, the capacitor portion 10B can be continuously used. By using the first terminal electrode 3 and the external connection conductors 6A and 6B, presence or absence of a short circuit failure in the capacitor portions 10 A and 10B can be measured and inspected.

Here, as illustrated in FIG. 7C, in the electronic component 200 in the comparative example, the electric field intensity increases in the vicinity of edges on central sides of the internal electrodes 11 and 12 (see also FIGS. 5A and 5B) due to an effect of the coupling portions CT. There is a possibility, therefore, that a crack CRX starting from an electric field enhancement portion at the edges on the central sides of the internal electrodes 11 and 12 occurs. In the present embodiment, on the other hand, the third internal electrodes 13 have an opening portion 30 in a region between the first internal electrodes 11 and the second internal electrodes 12 when viewed in the Z-axis direction. The electric field intensity, therefore, can be reduced in the vicinity of the region between the first internal electrodes 11 and the second internal electrodes 12. As a result, cracks in the element body 2 due to electric field enhancement can be suppressed. Performance of the electronic component 100 including a plurality of capacitor portions connected in series with each other can thus be improved.

The gap 25 formed by the opening portion 30 is formed between the capacitor portion 10A and the capacitor portion 10B. As illustrated in FIG. 7B, therefore, a crack CR caused in the capacitor portion 10A hardly reaches the other capacitor portion 10B along the coupling portions CT. It is therefore possible to suppress a short circuit due to a crack CR in both capacitor portions 10A and 10B.

The third internal electrodes 13 may include a first region 21 closer to the first end surface 2c than the opening portion 30, a second region 22 closer to the second end surface 2d than the opening portion 30, and connection portions 23 and 24 that couple the first region 21 and the second region 22 with each other, and the connection portions 23 and 24 may be formed on the side surfaces 2e and 2f, on which the external connection conductors 6A and 6B are provided. In this case, the connection portions 23 and 24 can be brought close to the external connection conductors 6A and 6B. By shortening length of the lead-out portions 26 and 27 to the external connection conductors 6A and 6B of the third internal electrodes 13, therefore, Joule heat due to currents to the lead-out portions 26 and 27 can be reduced, and a possibility of damage due to the Joule heat can be reduced.

The external connection conductors 6A and 6B may be formed on the first side surface 2e and the second side surface 2f, respectively, and the third internal electrodes 13 may include, as connection portions, a first connection portion 23 connected to the external connection conductor 6A on the first side surface 2e and a second connection portion 24 connected to the external connection conductor 6B on the second side surface 2f. In this case, presence or absence of a short circuit failure can be measured and inspected using the external connection conductor 6A or 6B on either the first side surface 2e or the second side surface 2f.

The width W2 of the connection portions 23 and 24 of the third internal electrodes 13 in the Y-axis direction may be 10% or more of the overlapping width W1 of the first capacitor portion 10A and the second capacitor portion 10B in the Y-axis direction. In this case, by securing the width of the connection portions 23 and 24, Joule heat due to currents can be reduced, and damage due to the Joule heat can be suppressed.

The length L2 of the connection portions 23 and 24 of the third internal electrodes 13 in the X-axis direction may be 100% or less of the overlapping length L1 of the first capacitor portion 10A and the second capacitor portion 10B in the X-axis direction. In this case, by suppressing the length of the connection portions 23 and 24, Joule heat due to currents can be reduced, and damage due to the Joule heat can be suppressed.

The width W2 of the connection portions 23 and 24 of the third internal electrodes 13 in the Y-axis direction may be larger than the width W3, in the X-axis direction, of the lead-out portions 26 and 27 connected to the external connection conductors 6A and 6B. In this case, by securing the width of the connection portions 23 and 24, it is possible to reliably achieve connectivity with the external connection conductors 6A and 6B while reducing Joule heat due to currents.

The width W4 of the opening portion 30 in the X-axis direction may be twice or more as large as the thickness T, in the Z-axis direction, of the dielectric layer 5 (first dielectric layer) between the first and second internal electrodes 11 and 12 and the third internal electrodes 13. In this case, it is possible to improve withstand voltage performance near the opening portion 30 equal to or more than interlayer withstand voltage performance of the dielectric layers 5.

The present invention is not limited to the embodiment described above.

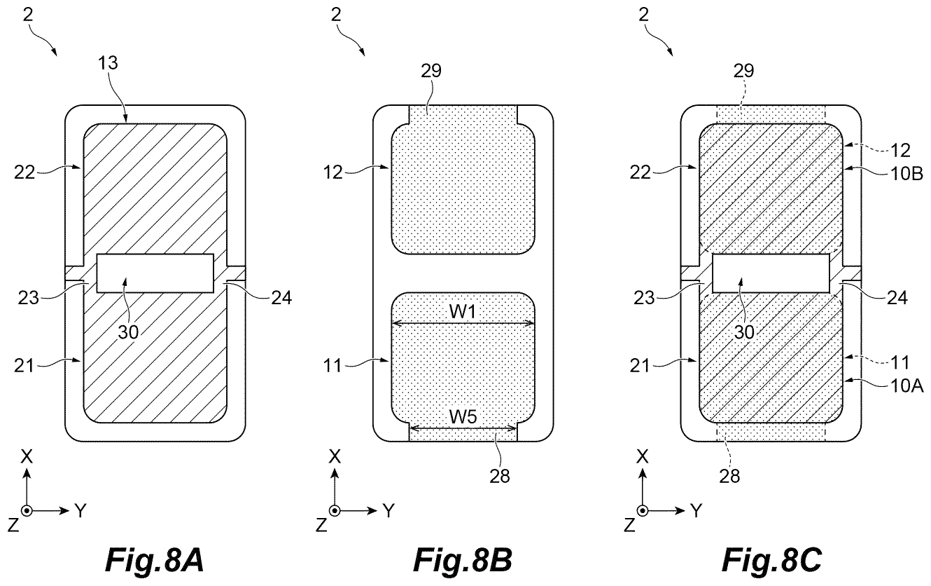

Shapes of the internal electrodes 11 and 12 are not limited to the above-described embodiment. For example, a configuration illustrated in FIGS. 8A to 8C may be employed. In the example illustrated in FIGS. 8A to 8C, the first lead-out portion 28 and the second lead-out portion 29 may be narrower than the first capacitor portion 10A and the second capacitor portion 10B in the Y-axis direction. That is, a width W5 of the lead-out portions 28 and 29 in the Y-axis direction is smaller than the overlapping width W1 of the capacitor portions 10A and 10B. Although not particularly limited, the width W5 may be 90% or less of the overlapping width W1. Note that a lower limit value of the width W5 may be set within a range in which the area of the lead-out portions 28 and 29 becomes larger than that of the connection portions 23 and 24 as described above.

As described above, the first internal electrodes 11 may include a first lead-out portion 28 led out from the first capacitor portion 10A to the first terminal electrode 3, the second internal electrodes 12 may include a second lead-out portion 29 led out from the second capacitor portion 10B to the second terminal electrode 4, and the first lead-out portion 28 and the second lead-out portion 29 may be narrower than the first capacitor portion 10A and the second capacitor portion 10B in the Y-axis direction. Electric field enhancement as illustrated in FIGS. 5A and 5B can also occur near edges of the first capacitor portion 10A and the second capacitor portion 10B on end surfaces 2c and 2d sides. By employing the configuration illustrated in FIGS. 8A to 8C, regions of the first and second internal electrodes 11 and 12 overlapping edges of the third internal electrodes 13 can be reduced. The electric field intensity can therefore be reduced in the vicinity of the end surfaces 2c and 2d to reduce cracks.

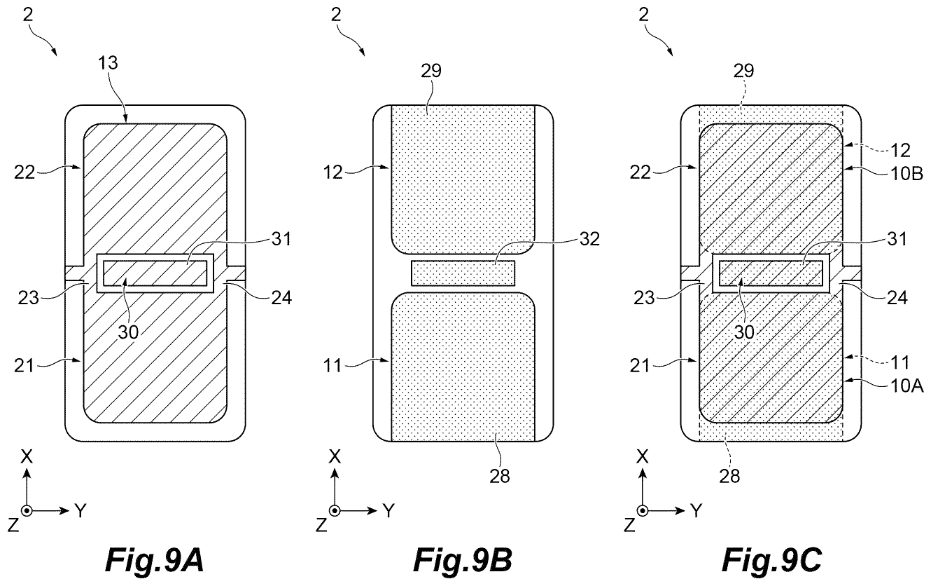

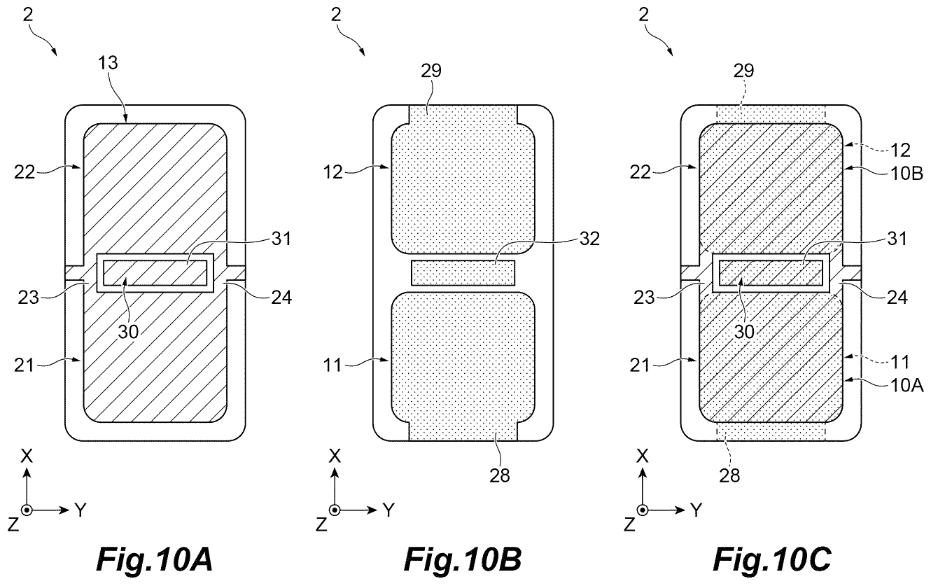

A structure illustrated in FIGS. 9A to 9C may be employed. In the example illustrated in FIGS. 9A to 9C, a first mitigation layer 31 that mitigates formation of a recess in the element body 2 is formed inside the opening portion 30. A second mitigation layer 32 that mitigates formation of a recess in the element body 2 is formed between the first internal electrodes 11 and the second internal electrodes 12. The first mitigation layer 31 and the second mitigation layer 32 may be conductor layers or second dielectric layers. The mitigation layers 31 and 32 as second dielectric layers are dielectric layers different from the dielectric layers 5 (first dielectric layers) between the first and second internal electrodes 11 and 12 and the third internal electrodes 13. The dielectric layers of the mitigation layers 31 and 32 have a level of strength with which a recess is less likely to be formed than the dielectric layers 5. The first mitigation layer 31 is separated from the third internal electrodes 13. The second mitigation layer 32 is separated from the internal electrodes 11 and 12. Size of the mitigation layers 31 and 32 with respect to the opening portion 30 are not particularly limited, but for example, the area of the mitigation layers 31 and 32 may be 97% or less, and more preferably 80% or less, of the area of the opening portion 30. Note that, as illustrated in FIGS. 10A to 10C, a configuration in which the lead-out portions 28 and 29 are narrower than in the configuration in FIGS. 9A to 9C may be employed. Only when the second dielectric layers are employed, however, the first mitigation layer 31 and the second mitigation layer 32 may be formed in such a way as to overlap the opening portion 30 and the edges of the internal electrodes 11 and 12.

As described above, the first mitigation layer 31 that mitigates formation of a recess in the element body 2 may be formed inside the opening portion 30. In this case, recesses in the main surfaces 2a and 2b of the element body 2 can be reduced. The main surfaces 2a and 2b can be used as surfaces to be sucked by a suction tool when the element body 2 is conveyed. By reducing recesses in the main surfaces 2a and 2b, pickup of the element body 2 through suction becomes easy.

A second mitigation layer 32 that mitigates formation of a recess in the element body 2 may be formed between the first internal electrodes 11 and the second internal electrodes 12. In this case, recesses in the main surfaces 2a and 2b of the element body 2 can be reduced. Pickup of the element body 2 through suction, therefore, becomes easy.

The first mitigation layer 31 and the second mitigation layer 32 may be conductor layers or second dielectric layers. In this case, recesses in the main surfaces 2a and 2b of the element body 2 can be reduced by sufficiently supporting the inside of the opening portion 30 with the conductor layers or the second dielectric layers. Pickup of the element body 2 through suction, therefore, becomes easy.

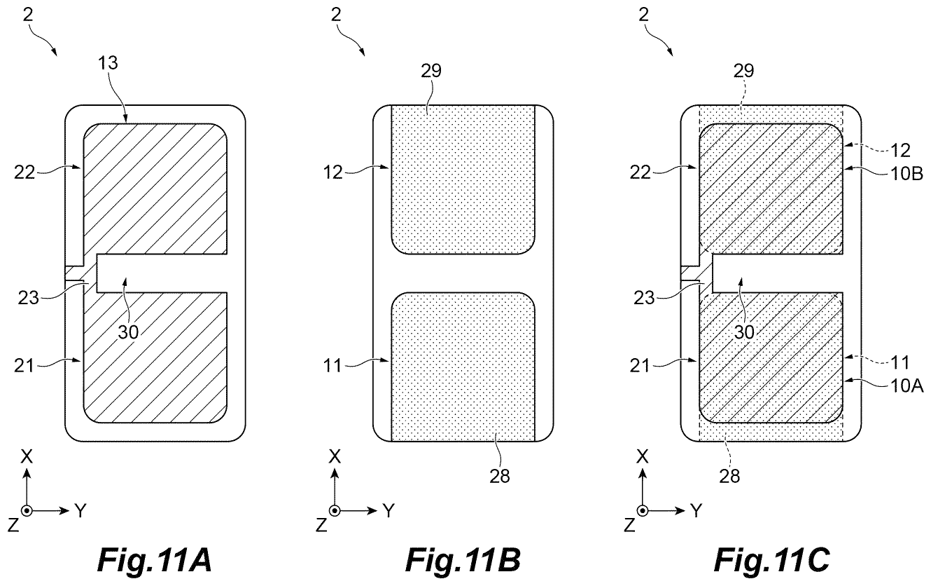

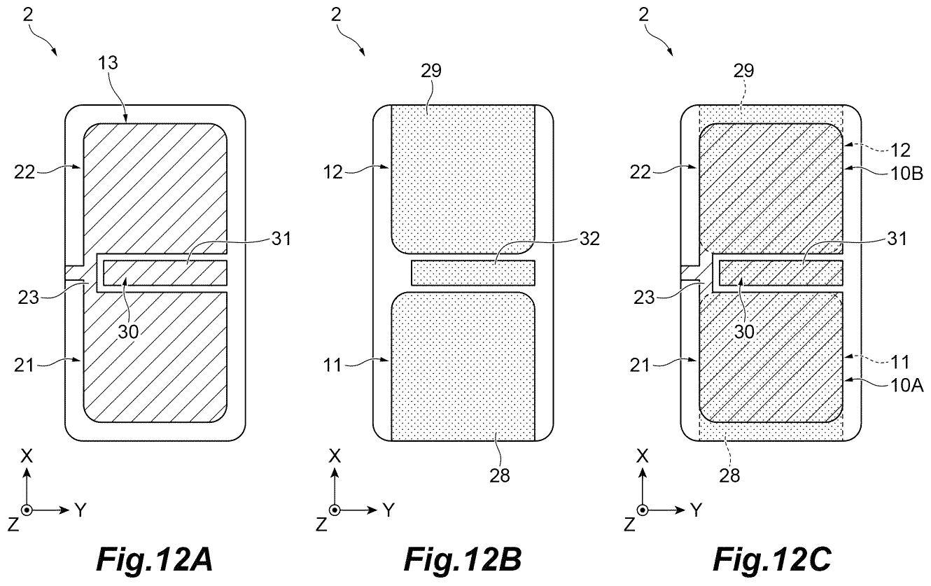

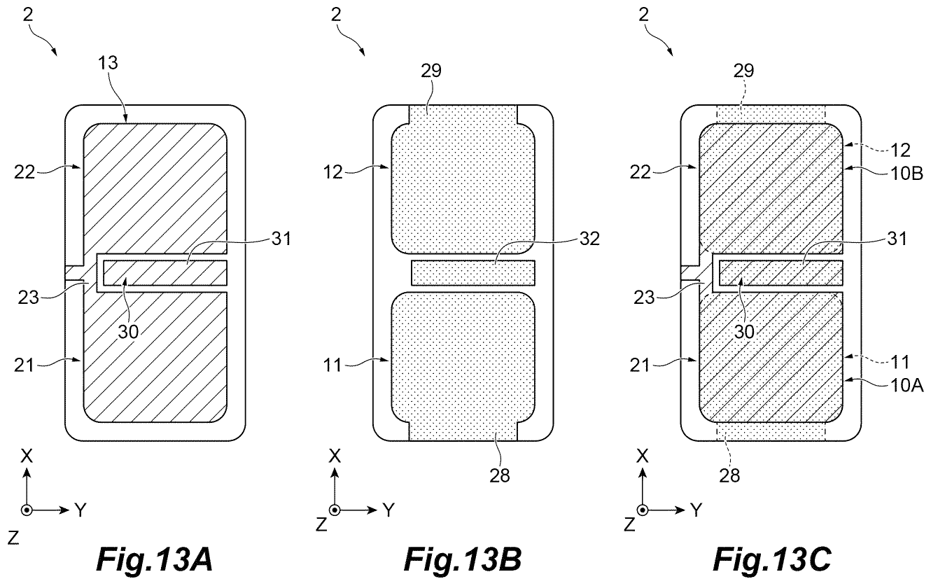

The connection portions need not be provided on both sides in the Y-axis direction, and it is only required that one of the connection portions 23 and 24 be provided. In an example illustrated in FIGS. 11A to 11C, the connection portion 24 is omitted, and the third internal electrodes 13 include only the connection portion 23. The opening portion 30 opens on the positive side in the Y-axis direction. As illustrated in FIGS. 12A to 12C, a configuration in which the mitigation layers 31 and 32 are provided for the configuration in FIGS. 11A to 11C may be employed. Note that, as illustrated in FIGS. 13A to 13C, a configuration in which the lead-out portions 28 and 29 are narrower than in the configuration in FIGS. 12A to 12C may be employed.

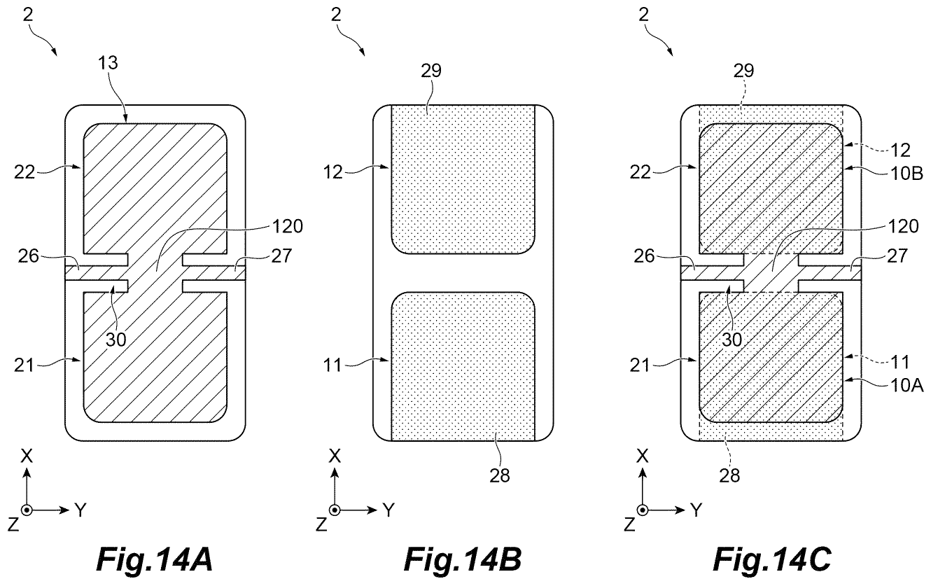

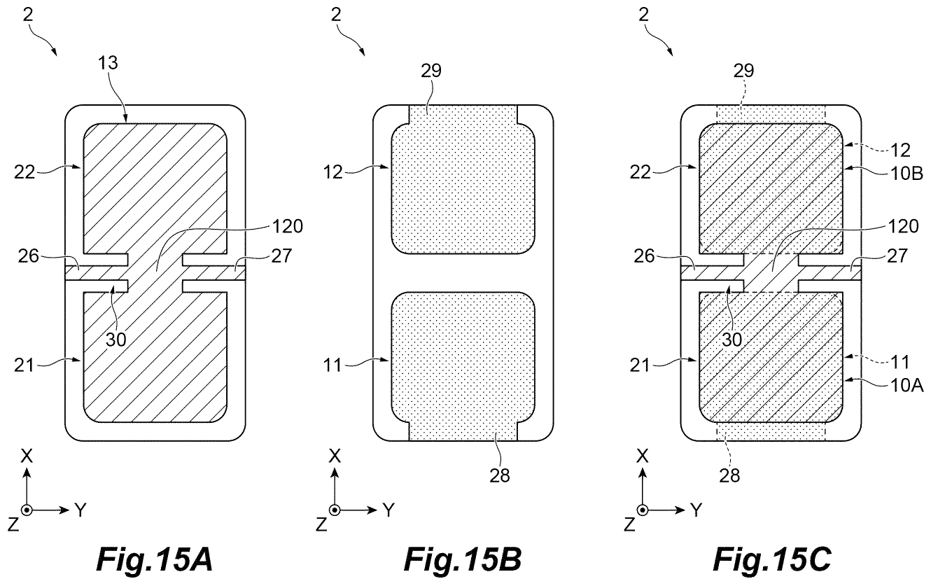

As illustrated in FIGS. 14A to 14C, a connection portion 120 may be provided at a central position in the Y-axis direction. The lead-out portions 26 and 27 are provided in such a way as to extend from the connection portion 120 to both sides in the Y-axis direction. At this time, opening portions 30 are formed between the lead-out portions 26 and 27 and the first region 21 and between the lead-out portions 26 and 27 and the second region 22. Note that, as illustrated in FIGS. 15A to 15C, a configuration in which the lead-out portions 28 and 29 are narrower than in the configuration in FIGS. 13A to 13C may be employed.

The shape of the element body 2 is not limited to a rectangular parallelepiped shape as long as the element body 2 has a pair of main surfaces facing each other and side surfaces extending between the main surfaces.

### [Form 1]

An electronic component including:
an element body having a first main surface and a second main surface facing each other in a first direction, a first end surface and a second end surface facing each other in a second direction, which is perpendicular to the first direction, and a first side surface and a second side surface facing each other in a third direction perpendicular to the first direction and the second direction;
a first terminal electrode formed on the first end surface;
a second terminal electrode formed on the second end surface;
an external connection conductor formed on at least one of the first side surface and the second side surface;
a first internal electrode provided in the element body and connected to the first terminal electrode at the first end surface;
a second internal electrode provided in the element body, separated from the first internal electrode, and connected to the second terminal electrode at the second end surface; and
a third internal electrode provided in the element body, facing the first internal electrode and the second internal electrode in the first direction, and connected to the external connection conductor,
in which
a first capacitor portion formed by the first internal electrode and the third internal electrode facing each other and a second capacitor portion formed by the second internal electrode and the third internal electrode facing each other are connected in series with each other, and
the third internal electrode has an opening portion in a region between the first internal electrode and the second internal electrode when viewed in the first direction.

### [Form 2]

The electronic component according to Form 1, in which
the third internal electrode includes:
   a first region closer to the first end surface than the opening portion;
   a second region closer to the second end surface than the opening portion; and
   a connection portion that couples the first region and the second region with each other, and
the connection portion is formed on a side surface on which the external connection conductor is provided.

### [Form 3]

The electronic component according to Form 2, in which
the external connection conductor is formed on the first side surface and the second side surface, and
the third internal electrode includes, as the connection portion, a first connection portion connected to the external connection conductor on the first side surface and a second connection portion connected to the external connection conductor on the second side surface.

### [Form 4]

The electronic component according to Form 2 or 3, in which a width of the connection portion of the third internal electrode in the third direction is 10% or more of an overlapping width of the first capacitor portion and the second capacitor portion in the third direction.

### [Form 5]

The electronic component according to any one of Forms 2 to 4, in which a length of the connection portion of the third internal electrode in the second direction is 100% or less of an overlapping length of the first capacitor portion and the second capacitor portion in the second direction.

### [Form 6]

The electronic component according to any one of Forms 2 to 5, in which a width of the connection portion of the third internal electrode in the third direction is larger than a width of a lead-out portion connected to the external connection conductor in the second direction.

### [Form 7]

The electronic component according to any one of Forms 1 to 6, in which
the first internal electrode includes a first lead-out portion led out from the first capacitor portion to the first terminal electrode,
the second internal electrode includes a second lead-out portion led out from the second capacitor portion to the second terminal electrode, and
the first lead-out portion and the second lead-out portion are narrower than the first capacitor portion and the second capacitor portion in the third direction.

### [Form 8]

The electronic component according to any one of Forms 1 to 7, in which a width of the opening portion in the second direction is twice or more as large as a thickness of a first dielectric layer between the first and second internal electrodes and the third internal electrode in the first direction.

### [Form 9]

The electronic component according to any one of Forms 1 to 8, in which a first mitigation layer that mitigates formation of a recess in the element body is formed inside the opening portion.

### [Form 10]

The electronic component according to any one of Forms 1 to 9, in which a second mitigation layer that mitigates formation of a recess in the element body is formed between the first internal electrode and the second internal electrode.

### [Form 11]

The electronic component according to Form 9, wherein the first mitigation layer is conductor layers or second dielectric layers.

### [Form 12]

The electronic component according to Form 10, wherein the second mitigation layer are conductor layers or second dielectric layers.
2 Element body
2a First main surface
2b Second main surface
2c First end surface
2d Second end surface
2e First side surface
2f Second side surface
3 First terminal electrode
4 Second terminal electrode
5 Dielectric layer
6A, 6B External connection conductor
10A First capacitor portion
10B Second capacitor portion
11 First internal electrode
12 Second internal electrode
13 Third internal electrode
21 First region
22 Second region
23 First connection portion
24 Second connection portion
26, 27 Lead-out portion
28 First lead-out portion
29 Second lead-out portion
30 Opening portion
31 First mitigation layer
32 Second mitigation layer
100 Electronic component

What is claimed is:

1. An electronic component comprising:
an element body having a first main surface and a second main surface facing each other in a first direction, a first end surface and a second end surface facing each other in a second direction perpendicular to the first direction, and a first side surface and a second side surface facing each other in a third direction perpendicular to the first and the second direction;
a first terminal electrode formed on the first end surface;
a second terminal electrode formed on the second end surface;
an external connection conductor formed on at least one of the first side surface and the second side surface;
a first internal electrode provided in the element body and connected to the first terminal electrode at the first end surface;
a second internal electrode provided in the element body, separated from the first internal electrode, and connected to the second terminal electrode at the second end surface; and
a third internal electrode provided in the element body, facing the first internal electrode and the second internal electrode in the first direction, and connected to the external connection conductor,
wherein
a first capacitor portion formed by the first internal electrode and the third internal electrode facing each other and a second capacitor portion formed by the second internal electrode and the third internal electrode facing each other are connected in series with each other, and
the third internal electrode has an opening portion in a region between the first internal electrode and the second internal electrode when viewed in the first direction.

2. The electronic component according to claim 1, wherein
the third internal electrode includes:
a first region closer to the first end surface than the opening portion;
a second region closer to the second end surface than the opening portion; and
a connection portion that couples the first region and the second region with each other, and
the connection portion is formed on a side surface on which the external connection conductor is provided.

3. The electronic component according to claim 2, wherein
the external connection conductor is formed on the first side surface and the second side surface, and
the third internal electrode includes, as the connection portion, a first connection portion connected to the external connection conductor on the first side surface and a second connection portion connected to the external connection conductor on the second side surface.

4. The electronic component according to claim 2, wherein a width of the connection portion of the third internal electrode in the third direction is 10% or more of an overlapping width of the first capacitor portion and the second capacitor portion in the third direction.

5. The electronic component according to claim 2, wherein a length of the connection portion of the third internal electrode in the second direction is 100% or less of an overlapping length of the first capacitor portion and the second capacitor portion in the second direction.

6. The electronic component according to claim 2, wherein a width of the connection portion of the third internal electrode in the third direction is larger than a width of a lead-out portion connected to the external connection conductor in the second direction.

7. The electronic component according to claim 1, wherein
the first internal electrode includes a first lead-out portion led out from the first capacitor portion to the first terminal electrode,
the second internal electrode includes a second lead-out portion led out from the second capacitor portion to the second terminal electrode, and
the first lead-out portion and the second lead-out portion are narrower than the first capacitor portion and the second capacitor portion in the third direction.

8. The electronic component according to claim 1, wherein a width of the opening portion in the second direction is twice or more as large as a thickness of a first dielectric layer between the first and second internal electrodes and the third internal electrode in the first direction.

9. The electronic component according to claim 1, wherein a first mitigation layer that mitigates formation of a recess in the element body is formed inside the opening portion.

10. The electronic component according to claim 1, wherein a second mitigation layer that mitigates formation of a recess in the element body is formed between the first internal electrode and the second internal electrode.

11. The electronic component according to claim 9, wherein the first mitigation layer is conductor layers or second dielectric layers.

12. The electronic component according to claim 10, wherein the second mitigation layer are conductor layers or second dielectric layers.
